(19) United States
(12) Patent Application Publication
(10) Pub. No.: US 2025/0037157 A1
(43) Pub. Date: Jan. 30, 2025

(54) SYSTEMS AND METHODS FOR MACHINE LEARNING-BASED EMULATION OF VIRTUAL RESPONDENTS

(71) Applicant: SimSurveys, LLC, Chicago, IL (US)

(72) Inventors: Joel Friedman, Chicago, IL (US); Myles Friedman, Chicago, IL (US)

(73) Assignee: SimSurveys, LLC, Chicago, IL (US)

(21) Appl. No.: 18/784,418

(22) Filed: Jul. 25, 2024

Related U.S. Application Data
(60) Provisional application No. 63/675,446, filed on Jul. 25, 2024.
(60) Provisional application No. 63/534,452, filed on Aug. 24, 2023.
(60) Provisional application No. 63/528,781, filed on Jul. 25, 2023.

(51) Int. Cl. G06Q 30/0203; G06Q 30/0204

(52) U.S. Cl. CPC G06Q 30/0203; G06Q 30/0205

(57) ABSTRACT

A system and method for automated generation of simulated responses from one or more virtual emulated respondents includes collecting a reference survey artifact comprising unanswered questions, obtaining demographic data for the one or more virtual emulated respondents, constructing a demographic vector for each virtual emulated respondent representing the characteristics of the associated virtual emulated respondent, generating responses for each target virtual emulated respondent to each unanswered question by transmitting inputs including the associated demographic vector, each unanswered question, and an iterative contextual parameter to a response generation model, and updating a simulated response dataset with the generated responses.

### CROSS-REFERENCE TO RELATED APPLICATIONS

This application claims the benefit of U.S. Provisional Patent Application No. 63/528,781, filed 25 Jul. 2023, U.S. Provisional Patent Application 63/534,452, filed 25 Aug. 2023, and U.S. Provisional Patent Application 63/675,446 filed 25 Jul. 2024, which are incorporated in their entirety by reference.

### TECHNICAL FIELD

The inventions herein relate generally to the machine learning-based data curation and collection fields, and more specifically to a new and useful system and method for emulating virtual respondents using machine learning in the machine learning-based data curation and collection fields.

### BACKGROUND

Modern data collection technologies employ various methods to extract, acquire, and/or store information from individual members of a population. These methods may typically include data obtained through use of surveys and questionnaires, many of which may be completed by individuals electronically. However, collecting information through such methods may be difficult or even impossible due to unreliable data generated by autonomous programs posing as individual respondents, distracted or inattentive respondents, and malicious actors. In addition, it is often challenging to collect data from a significant or required number of individuals of various populations.

Therefore, there is a need in the data curation and collection fields to create improved systems and methods for implementing machine learning-based approaches to emulate virtual respondents and generate simulated responses to surveys and questionnaires. The embodiments of the present application described herein provide technical solutions that address, at least, the needs described above, as well as the deficiencies of the state of the art.

### BRIEF SUMMARY OF THE INVENTION(S)

In some embodiments, a method for an automated generation of simulated responses from a virtual emulated respondent, includes collecting, via one or more computers, a reference survey artifact comprising one or more unanswered questions; obtaining, via the one or more computers, demographic data comprising one or more demographic features; constructing a demographic vector based on the demographic data, wherein the demographic vector represents one or more demographic characteristics of a target virtual emulated respondent; generating a response to each distinct unanswered question for the target virtual emulated respondent, wherein generating the response to each distinct unanswered question comprises: routing a set of inputs to one of a nominal response generation model or an ordinal response generation model, wherein the set of inputs includes the demographic vector, the distinct unanswered question, and an iterative contextual parameter, and generating, via the nominal response generation model or the ordinal response generation model, a response to the distinct unanswered question; and updating a simulated response dataset to include each generated response of the target virtual emulated respondent.

In some embodiments, generating the response to each distinct unanswered question further comprises determining whether the distinct unanswered question is a nominal question or an ordinal question, and routing the set of inputs to one of the nominal response generation model or the ordinal response generation model further comprises: routing the set of inputs to the nominal response generation model if the distinct unanswered question is a nominal question, or routing the set of inputs to the ordinal response generation model if the distinct unanswered question is an ordinal question.

In some embodiments, computing the response to the distinct unanswered question further comprises computing, via the nominal response generation model or the ordinal response generation model, one or more context-question vectors comprising an n-dimensional vector representation of the distinct unanswered question and the iterative contextual parameter.

In some embodiments, computing the one or more context-question vectors comprises computing, via the nominal response generation model, a context-question vector of the one or more context-question vectors for each possible response to the distinct unanswered question, wherein each context-question vector comprises an n-dimensional vector representation of the distinct unanswered question, the corresponding possible response, and the iterative contextual parameter.

In some embodiments, computing the response to the distinct unanswered question further comprises computing, via the ordinal response generation model, an ordinal context-question vector comprising an n-dimensional vector representation of the distinct unanswered question, an ordinal question category of the distinct unanswered question, and the iterative contextual parameter.

In some embodiments, the iterative contextual parameter comprises one or more previously generated responses of the target virtual emulated respondent.

In some embodiments, computing the response to the distinct unanswered question further comprises computing, via the nominal response generation model or the ordinal response generation model, a response probability score for each possible response to the distinct unanswered question, and selecting, via the nominal response generation model or the ordinal response generation model, the generated response from among the possible responses based on the computed response probability scores.

In some embodiments, the reference survey artifact comprises one or more previously answered questions by at least one historical respondent, and the one or more unanswered questions include one or more questions that the at least one historical respondent did not previously answer, wherein the target virtual emulated respondent represents a virtual emulation of the at least one target historical respondent.

In some embodiments, constructing the demographic vector further comprises automatically selecting values for one or more characteristic indices of the demographic vector, wherein each characteristic index is associated with a distinct demographic characteristic.

In some embodiments, generating the response to each distinct unanswered question further comprises updating the iterative contextual parameter to include the generated response and the distinct unanswered question.

In some embodiments, a method for an automated generation of simulated responses from one or more virtual emulated respondents, comprises collecting, via one or more computers, a reference survey artifact comprising one or more unanswered questions; obtaining, via the one or more computers, demographic group data comprising one or more demographic features of one or more demographic groups of one or more virtual emulated respondents; constructing one or more demographic vectors based on the demographic group data, wherein each demographic vector represents one or more demographic characteristics of a distinct demographic group of the one or more demographic groups; iteratively generating, for each distinct virtual emulated respondent in each demographic group, a simulated response to each distinct unanswered question, wherein iteratively generating a simulated response includes: routing a set of inputs to one of a nominal response generation model or an ordinal response generation model based on a question type of the distinct unanswered question, wherein the set of inputs comprises the distinct unanswered question and the demographic vector corresponding to the demographic group of the distinct virtual emulated respondent, computing, via the nominal response generation model or the ordinal response generation model, a response probability vector comprising one or more probability values corresponding to one or more possible responses of the distinct virtual emulated respondent to the distinct unanswered question, automatically selecting the simulated response from the one or more possible responses based on the response probability vector, and updating a simulated response dataset to include the selected simulated response.

In some embodiments, iteratively generating the simulated response further comprises determining whether the distinct unanswered question is a nominal question or an ordinal question, and routing the set of inputs to one of the nominal response generation model or the ordinal response generation model further comprises routing the set of inputs to the nominal response generation model if the distinct unanswered question is a nominal question, or routing the set of inputs to the ordinal response generation model if the distinct unanswered question is an ordinal question.

In some embodiments, computing the response probability vector further comprises computing, via the nominal response generation model or the ordinal response generation model, one or more context-question vectors comprising an n-dimensional vector representation of the distinct unanswered question and an iterative contextual parameter comprising one or more previously generated simulated responses of the distinct virtual emulated respondent.

In some embodiments, computing the one or more context-question vectors comprises computing, via the nominal response generation model, a context-question vector of the one or more context-question vectors for each possible response to the distinct unanswered question, wherein each context-question vector comprises an n-dimensional vector representation of the distinct unanswered question, the corresponding possible response, and the iterative contextual parameter.

In some embodiments, computing the response probability vector further comprises computing, via the ordinal response generation model, an ordinal context-question vector comprising an n-dimensional vector representation of the distinct unanswered question, an ordinal question category of the distinct unanswered question, and an iterative contextual parameter comprising one or more previously generated simulated responses of the distinct virtual emulated respondent.

In some embodiments, a method for an automated generation of one or more simulated responses from a virtual emulated respondent, includes configuring a virtual respondent emulation system, wherein configuring the virtual respondent emulation system comprises collecting a reference survey artifact comprising one or more survey questions; constructing a demographic vector representing one or more demographic characteristics of a virtual emulated respondent; computing, via a question contextualization model, one or more context-question vectors for each distinct survey question based on a text input comprising a contextual parameter and the distinct survey question, wherein the contextual parameter comprises one or more previous responses of the virtual emulated respondent; computing, via a response confidence scoring model, a simulated response probability vector for each distinct survey question based on an input of the demographic vector and the one or more context-question vectors corresponding to the distinct survey question; identifying a simulated response of the virtual emulated respondent to each distinct survey question based on the simulated response probability vector associated with each distinct survey question; and installing the identified simulated responses into a simulated response dataset.

In some embodiments, computing the one or more context-question vectors for each distinct survey question further comprises determining whether the distinct survey question is a nominal question or an ordinal question, computing a nominal context-question vector for each possible response to the distinct survey question if the distinct survey question is a nominal question, wherein each context-question vector comprises an n-dimensional vector representation of the distinct survey question, the corresponding possible response, and the contextual parameter, or computing an ordinal context-question vector if the distinct survey question is an ordinal question, wherein the ordinal context-question vector comprises an n-dimensional vector representation of the distinct survey question, an ordinal question category of the distinct survey question, and the contextual parameter.

In some embodiments, identifying the simulated response of the virtual emulated respondent to each distinct survey question further comprises appending the distinct survey question and the identified simulated response to the contextual parameter.

In some embodiments, the reference survey artifact comprises one or more previously answered questions by at least one historical respondent, and the one or more survey questions include one or more questions that the at least one historical respondent did not previously answer, wherein constructing the demographic vector further comprises constructing the demographic vector based on demographic data of the at least one target historical respondent.

In some embodiments, constructing the demographic vector further comprises automatically selecting values for one or more characteristic indices of the demographic vector, wherein each characteristic index is associated with a distinct demographic characteristic.

In some embodiments, a computer-implemented method for an automated generation of simulated responses from a virtual emulated respondent includes collecting a reference survey artifact comprising one or more unanswered questions; obtaining demographic data comprising one or more demographic features; constructing, via one or more computers, a demographic vector based on the demographic data, wherein the demographic vector represents one or more demographic characteristics of a target virtual emulated respondent; generating, via the one or more computers, a response to each distinct unanswered question for the target virtual emulated respondent, wherein generating the response to each distinct unanswered question comprises: transmitting a set of inputs to a multi-task nominal-ordinal response generation model, wherein the set of inputs includes the demographic vector, the distinct unanswered question, and an iterative contextual parameter, and generating, via the multi-task nominal-ordinal response generation model, a simulated response to the distinct unanswered question; updating, via the one or more computers, a simulated response dataset to include each generated response of the target virtual emulated respondent; and storing the simulated response dataset in a queryable computer database accessible, via a user interface, for augmenting or completing a target reference survey artifact with one or more simulated responses of the simulated response dataset.

In some embodiments, generating the response to each distinct unanswered question further comprises: computing, via the multi-task nominal-ordinal response generation model, a nominal context-question vector for each possible response to the distinct unanswered question if the distinct unanswered question is a nominal question, wherein each context-question vector comprises an n-dimensional vector representation of the distinct unanswered question, the corresponding possible response, and the iterative contextual parameter, or computing, via the multi-task nominal-ordinal response generation model, an ordinal context-question vector if the distinct unanswered question is an ordinal question, wherein the ordinal context-question vector comprises an n-dimensional vector representation of the distinct unanswered question, an ordinal question category of the distinct unanswered question, and the iterative contextual parameter.

In some embodiments, generating the simulated response to the distinct unanswered question further comprises appending the distinct unanswered question and the simulated response to the iterative contextual parameter.

In some embodiments, the reference survey artifact comprises one or more previously answered questions by at least one historical respondent, and the one or more unanswered questions include one or more questions that the at least one historical respondent did not previously answer, wherein constructing the demographic vector further comprises constructing the demographic vector based on demographic data of the at least one historical respondent.

In some embodiments, constructing the demographic vector further comprises automatically selecting values for one or more characteristic indices of the demographic vector, wherein each characteristic index is associated with a distinct demographic characteristic of the one or more demographic characteristics.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates a schematic representation of an example nominal contextual question vector construction process in accordance with one or more embodiments of the present application;

FIG. 4 illustrates a schematic representation of an example simulated nominal response identification process in accordance with one or more embodiments of the present application;

FIG. 5 illustrates a schematic representation of an example ordinal contextual question vector construction process in accordance with one or more embodiments of the present application;

FIG. 6 illustrates a schematic representation of an example simulated ordinal response identification process in accordance with one or more embodiments of the present application;

FIG. 7 illustrates a schematic representation of an example routing of nominal and ordinal questions to nominal and ordinal response generation models in accordance with one or more embodiments of the present application; and

FIG. 8 illustrates a schematic representation of an example multi-task response generation model in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1. System for Machine Learning-Based Emulation of Virtual Respondents

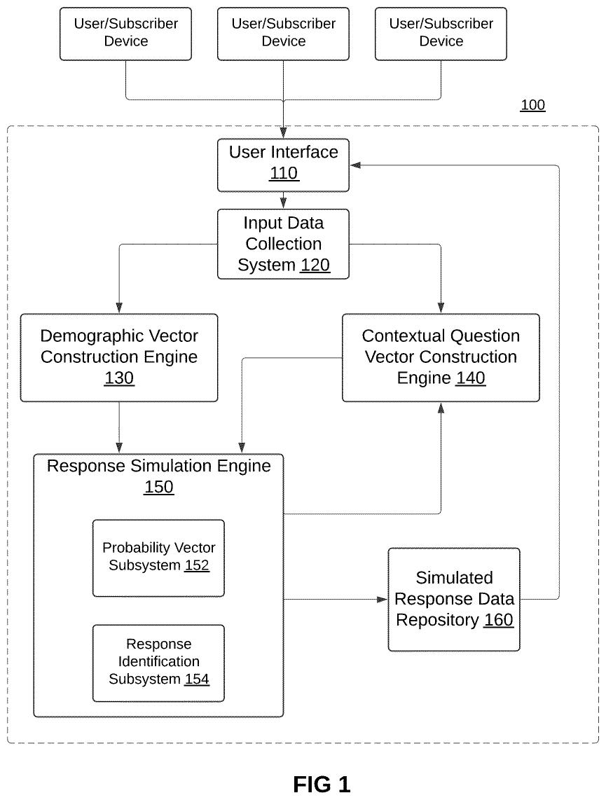

As shown in FIG. 1, a system 100 for machine learning-based emulation of virtual respondents may include a respondent emulation user interface 110, an input data collection system 120, a demographic vector construction engine 130, a contextual question vector construction engine 140, and a response simulation engine 150. Additionally, in some embodiments, system 100 may include a simulated response data repository 160.

### 1.1 Respondent Emulation User Interface

The respondent emulation user interface 110, sometimes referred to herein as a “user interface” 110, may preferably function to enable one or more users or subscribers of system 100 to provide input to and/or receive output from one or more components of system 100. In various embodiments, the one or more users may utilize user interface 110 to provide input including, but not limited to, reference survey or questionnaire artifacts (as described in 2.1), demographic or group identifying data (as described in 2.1), and/or any other data for input into the system 100. Additionally, or alternatively, in various embodiments, the one or more users or subscribers may utilize user interface 110 to receive output from system 100 including, but not limited to, simulated response datasets (as described in 2.5) and/or any other data output from system 100. In some embodiments, user interface 110 may additionally or alternatively function to enable the one or more users or subscribers of system 100 to configure or modify one or more components of system 100.

### 1.2 Input Data Collection System

The input data collection system 120 preferably functions to collect or receive input data related to an operation or iteration of system 100. In some preferred embodiments, input data collection system 120 may function to receive or collect demographic group data and/or reference survey artifacts from one or more users or subscribers via user interface 110.

### 1.3 Demographic Vector Construction Engine

The demographic vector construction engine 130 preferably functions to construct one or more demographic vectors (as described in 2.2). In some preferred embodiments, demographic vector construction engine 130 may function to construct the one or more demographic vectors based on input demographic group data. Accordingly, in some such embodiments, demographic vector construction engine 130 may be in operable communication with input data collection system 120 and/or user interface 110, such that demographic vector construction engine 130 may receive input demographic group data from input data collection system 120 and/or user interface 110. Alternatively, in some embodiments, demographic vector construction engine 130 may function to generate or construct one or more demographic vectors based on a configuration of system 100 and/or a configuration of demographic vector construction engine 130.

### 1.4 Contextual Question Vector Construction Engine

The contextual question (or contextual question-response) vector construction engine 140 preferably functions to construct one or more n-dimensional contextual question vectors (as described in 2.3). In some preferred embodiments, contextual question vector construction engine 140 may function to construct the one or more contextual question vectors based on one or more input reference survey artifacts and one or more contextual parameters. Accordingly, in some such embodiments, contextual question vector construction engine 140 may be in operable communication with input data collection system 120 and/or user interface 110, such that contextual question vector construction engine 140 may receive the one or more input reference survey artifacts from input data collection system 120 and/or user interface 110. In some preferred embodiments, contextual question vector construction engine 140 may be in operable communication with response simulation engine 150 and may function to receive or update the one or more contextual parameters based on input from response simulation engine 150.

### 1.5 Response Simulation Engine 150

The response simulation engine 150 preferably functions to implement and/or deploy one or more simulated response generation workflows that may compute or identify one or more simulated responses based on one or more inputs to response simulation engine 150. In such preferred embodiments, the simulated response generation workflows may include a simulated response probability computation workflow, a simulated response identification workflow, and/or any other suitable simulated response generation workflow. A simulated response probability computation workflow, as referred to herein, may relate to a workflow or process for computing one or more probabilities or confidence scores associated with one or more candidate responses (as described in 2.4). A simulated response identification workflow, as referred to herein, may relate to a workflow or process for identifying a particular or distinct response from a set of one or more responses as the simulated response to a given target question for a virtual emulated respondent (as described in 2.5). In some preferred embodiments, response simulation engine 150 may be in operable communication with and/or receive one or more demographic vector inputs from demographic vector construction engine 130 and/or one or more contextual question inputs from contextual question vector construction engine 140. In some embodiments, response simulation engine 150 may be in operable communication with simulated response data repository 160.

In one or more embodiments, response simulation engine 150 may include probability vector subsystem 152. In such embodiments, probability vector subsystem 152 may function to initiate, execute, and/or manage one or more simulated response probability computation workflows. In one or more embodiments, probability vector subsystem 152 may operate and/or be configured based on inputs of one or more demographic vectors and one or more contextual question vectors. In some preferred embodiments, probability vector subsystem 152 may function to compute one or more simulated response probability vectors (as described in 2.4).

In some embodiments, response simulation engine 150 may include response identification subsystem 154. In such embodiments, response identification subsystem 154 may function to initiate, execute, and/or manage one or more simulated response identification workflows. In various embodiments, response identification subsystem 154 may operate and/or be configured based on inputs of one or more simulated response probability vectors. Accordingly, in some such embodiments, response identification subsystem 154 may be in operable communication with and/or receive input from probability vector subsystem 152. In some embodiments, response identification subsystem 154 may function to identify one or more simulated responses (as described in 2.5). In various embodiments, response identification subsystem 154 may function to output the one or more identified simulated responses to simulated response data repository 160.

In various embodiments, response simulation engine 150, probability vector subsystem 152, response identification subsystem 154, and/or contextual question vector construction engine 140 may implement one or more machine learning algorithms and/or one or more ensembles of trained machine learning models. In such embodiments, semantic extraction module 125 may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation form transformers (BERT) for masked language model tasks and next sentence prediction tasks and the like, variations of BERT (i.e., ULMFIT, XLM UDify, MT-DNN, SpanBERT, ROBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), LLaMA, LLAMA 2 (and subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

### 1.6 Simulated Response Data Repository

In some embodiments, system 100 may include simulated response data repository 160. In such embodiments, simulated response data repository 160 may preferably function to receive and/or store one or more simulated response datasets (as described in 2.5). In one or more embodiments, simulated response data repository 160 may be in operable connection with one or more components of system 100, and simulated response data repository 160 may accordingly be queried by one or more components of system 100 to provide access to one or more stored simulated response datasets. Additionally, or alternatively, in various embodiments, simulated response data repository 160 may be queried by one or more users or subscribers via the user interface, such that the one or more users or subscribers may access or receive one or more stored simulated response datasets from simulated response data repository 160.

### 2. Method for Machine Learning-Based Emulation of Virtual Respondents

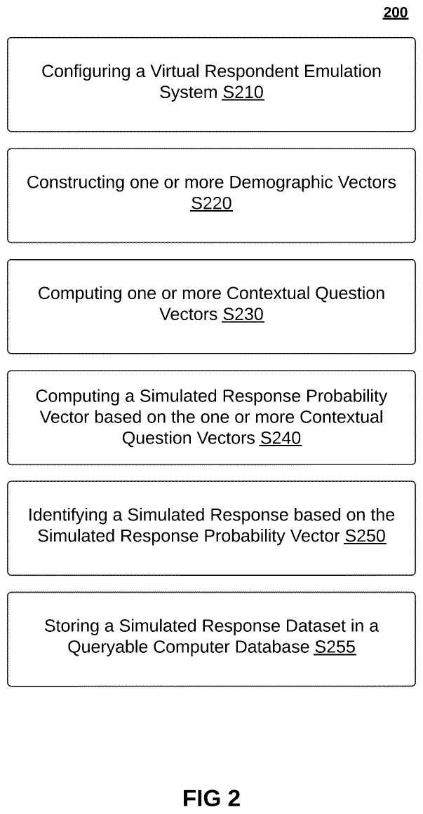

As shown in FIG. 2, a method 200 for machine learning-based emulation of one or more virtual survey respondents includes configuring a virtual respondent emulation system S210, constructing one or more demographic vectors S220, computing one or more contextual question vectors S230, computing a simulated response probability vector based on the one or more contextual question vectors S240, and identifying a simulated response based on the simulated response probability vector S250. Additionally, in some preferred embodiments, method 200 may include storing a simulated response dataset in a queryable computer database S255.

### 2.1 Configuring a Virtual Respondent Emulation System

S210, which includes configuring a virtual respondent emulation system, may function to configure and/or initialize a system for emulating one or more distinct virtual emulated respondents based on one or more user/subscriber inputs or requests. Preferably, the user inputs or requests may include one or more reference survey artifacts (or reference questionnaire artifacts), which may each relate to or include data including one or more questions and one or more answers or responses for each question. The user inputs or requests may additionally include demographic or identifying group data, which may include one or more demographic groups to be simulated and/or a number of distinct respondents or individuals of each demographic group to be emulated. Additionally, or alternatively, in some embodiments, S210 may function to configure an augmented data generation workflow for generating augmented response data based on the user inputs or requests.

### Virtual Emulated Respondent

Preferably, S210 may function to configure or initialize the virtual respondent emulation system to emulate one or more distinct virtual emulated respondents (sometimes referred to herein as “virtual respondents”). A virtual emulated respondent, as generally referred to herein, may relate to a distinct individual virtual persona or identity that may be emulated to respond to one or more questions or statements. In various embodiments, based on the configuration of the virtual respondent emulation system, the method 200 may generate or output simulated response data from one or more virtual emulated respondents.

### Reference Survey Artifact

Preferably, the user/subscriber inputs or requests may include a reference survey artifact. The reference survey artifact, as generally referred to herein, may relate to a data object comprising a list or series of one or more predetermined questions or statements and one or more responses or answers to each question or statement. In some preferred embodiments, the reference survey artifact may be in a survey format, such that each question may include or be associated with a set of one or more responses or answers (e.g., multiple choice questions), whereby each response or answer of the set may relate to a distinct opinion, experience, behavior, and/or the like of an individual respondent as defined by the associated question or statement. In one or more embodiments, the questions or statements and responses or answers of the reference survey artifact may be in the form of natural language statements and/or natural language utterances.

Preferably, the reference survey artifact may be input, uploaded, or otherwise provided by a user/subscriber to the virtual respondent emulation system. In some preferred embodiments, the reference survey artifact may be provided in a text format, such that each of the one or more questions and each of the associated responses may be provided in the form of text strings. Alternatively, the reference survey artifact may be provided or input in any suitable format for representing question and response data.

### Demographic or Identifying Group Data

In some preferred embodiments, the user inputs or requests may additionally include demographic group data (sometimes referred to herein as “respondent-identifying group data”). Demographic group data, as generally referred to herein, may relate to data that may identify, describe, and/or define one or more demographic characteristics or factors of an individual virtual emulated respondent or a group of individual virtual emulated respondents. Preferably, the one or more virtual emulated respondents may be emulated and/or identified based on one or more demographic characteristics. In various embodiments, demographic characteristics or factors may include, but may not be limited to, age, address, location, income, marital status, gender, race, occupation, and/or any other suitable demographic or identifying characteristic or factor.

Preferably, the demographic group data may include or identify one or more distinct demographic groups. In such preferred embodiments, each of the one or more distinct demographic groups may be identified or defined by one or more instances of demographic characteristics (sometimes referred to herein as demographic factors). For example, one distinct demographic group may be defined by a distinct instance of a demographic characteristic or factor (e.g., a particular or first age range), and another distinct demographic group may be defined by another distinct instance of the same, or other, demographic characteristic or factor (e.g., a different particular or second age range). In some embodiments, each distinct demographic group may be identified by a distinct set of demographic characteristics or factors, and each set of demographic characteristics or factors may include one or more distinct instances of a particular demographic characteristic or factor.

In some embodiments, user/subscriber input of demographic group data may additionally include a demographic sample population value that may indicate a number or quantity of individuals to be emulated (virtual emulated respondents) for each demographic group. In a first implementation, the input demographic group data may include the demographic sample population value, such that each distinct demographic group may be associated with a distinct number or quantity of individual respondents to be emulated. Additionally, or alternatively, in a second implementation, the input demographic group data may include a percentage or share value that may represent a percentage of individual respondents to be emulated (i.e., a percentage or share of a total number of virtually emulated individual respondents). In some such implementations, S210 may function to compute a demographic sample population value for each demographic group based on the percentage or share value. Additionally, or alternatively, in a third implementation, a quantity or number of virtual respondents to be emulated for each distinct demographic group may be identified or computed based on one or more sampling methods (e.g., random sampling from a virtual population of distinct demographic groups).

### Augmented Data Generation|Virtual Respondent Tracking

In one or more embodiments, S210 may function to configure or initiate an augmented data generation workflow. An augmented data generation workflow, as referred to herein, may relate to a workflow for augmenting the reference survey artifact with simulated response data from one or more virtual respondents based on historical respondent data (e.g., data associated with the reference survey artifact, and the like). In such embodiments, the reference survey artifact may include one or more previously answered questions or prompts that may be in the form of historical question-response pairs from one or more previous (historical) respondents. Additionally, in such embodiments, the reference survey artifact and/or the input data may include historical demographic data that may include a historical demographic vector or historical demographic group data for each historical respondent. In such embodiments, the augmented data generation workflow may function to virtually emulate one or more of the historical respondents based on the historical question-response pairs, the historical demographic vectors and/or historical demographic group data. Additionally, in some such embodiments, the augmented data generation workflow may function to generate simulated responses of the virtual emulated historical respondents to one or more unanswered questions in the reference survey artifact. Accordingly, in such embodiments, method 200 may function to augment the reference survey artifact by automatically generating responses for historical respondents to questions that they may have missed or otherwise did not answer.

As a non-limiting example, the reference survey artifact may include historical response data from one hundred historical respondents responding to twenty questions (i.e., twenty answered questions for each respondent), and the reference survey artifact may additionally include ten unanswered questions. In such an example, the historical response data may include twenty question-response pairs for each historical respondent, corresponding to the twenty answers or responses for each historical respondent. Additionally, in such an example, the reference survey artifact and/or the demographic group data may include historical demographic data that may be in the form of demographic vectors or historical demographic characteristic data for each historical respondent. In such an example, S210 may function to configure an augmented data generation workflow to virtually emulate the one hundred historical respondents based on the historical question-response pairs and the historical demographic data. Additionally, in such an example, the augmented data generation workflow may function to generate simulated responses to the ten unanswered questions for each virtual emulated historical respondent. Accordingly, in such an example, the augmented data generation workflow may augment the original reference survey artifact with the generated simulated responses to the ten unanswered questions for each virtual emulated historical respondent. It shall be noted that the above example is non-limiting, and S210 may function to configure an augmented data generation workflow with any number of answered questions, unanswered questions, and historical respondents.

### 2.2 Constructing One or More Demographic Vectors

S220, which includes constructing one or more demographic vectors, may function to construct one or more demographic vectors based on the user input of demographic group data and/or the configuration of the survey simulation system. Preferably, the demographic vector may include one or more components or values that may function to indicate a particular demographic characteristic or factor (e.g., age, race, income, or the like, as described in 2.1 above) of a distinct target demographic group and/or a distinct target virtually emulated respondent.

Preferably, the one or more demographic vectors may include one or more demographic characteristic indices (sometimes referred to herein as characteristic indices or demographic characteristic components), each of which may identify or represent a distinct characteristic instance or characteristic value of a distinct demographic characteristic or factor. A characteristic instance or characteristic value, as used herein, may relate to a specific instance or value of a demographic characteristic (for example, a specific age or age range for the demographic characteristic “age”). In one or more preferred embodiments, each demographic characteristic (for example, “age”) may be associated with a set of one or more demographic characteristic indices (for example, one or more ages or age ranges), wherein each demographic characteristic index may represent a distinct characteristic instance or value of the associated demographic characteristic (for example, each index associated with the characteristic “age” may represent a specific age value or age range value).

Preferably, each characteristic index may store an identity index value. An identity index value, as used herein, may relate to a value (for example, one or zero) in a characteristic index of the demographic vector that may indicate the target virtually emulated respondent either positively identifies (for example, a value of one) or does not identify (for example, a value of zero) with the characteristic instance or characteristic value (for example, a specific age range) of the demographic characteristic index. Preferably, each virtual emulated respondent may identify with only one distinct characteristic value for each demographic characteristic (for example, a virtual emulated respondent may identify with only one distinct age range value for the demographic characteristic “age” since the virtual emulated respondent has only one distinct age). Accordingly, in each demographic vector of such preferred embodiments, each set of characteristic indices associated with a particular demographic characteristic may include only one distinct characteristic index that may store an identity index value that may positively identify the virtual emulated respondent with the characteristic value of the characteristic index.

As a non-limiting example, in some embodiments, an identity index value of a demographic characteristic index may be either one or zero. In such an example, in some embodiments, a value of one may indicate that a current target virtual emulated respondent may be identified or positively identify with the demographic characteristic value represented by the characteristic index, and a value of zero may indicate that the current target virtually emulated respondent may not be identified or identify with the demographic characteristic represented by the characteristic index. It shall be noted that in some embodiments, demographic characteristic indices may include values other than one or zero, and in some embodiments may include decimal, fractional, or floating-point values.

As a non-limiting example, a demographic vector may include a first demographic characteristic index that may represent a first distinct age range, a second demographic characteristic index that may represent a second distinct age range, a third characteristic index that may represent a third distinct age range, a fourth demographic characteristic index that may represent a first distinct income range, a fifth demographic characteristic index that may represent a second distinct income range, and a sixth demographic characteristic index that may represent a third distinct income range. In the above non-limiting example of a demographic vector, a first set of three distinct demographic characteristic indices may represent the demographic characteristic of age and a second set of three distinct demographic characteristic indices may represent the demographic characteristic of income. In such a non-limiting example, each of the first set of three demographic characteristic indices may represent or identify a distinct value for an age (or age range), and each of the second set of three demographic characteristic indices may represent or identify a distinct value for an income (or income range). In such a non-limiting example, only one of the first set of characteristic indices representing age may store a positively identifying identity index value, and only one of the second set of three characteristic indices representing income may store a positively identifying identity index value. It shall be noted that the demographic vector may include any suitable number of demographic characteristic indices based on a number or quantity of demographic characteristic or factors.

In some preferred embodiments, S220 may function to construct a demographic vector for a current target virtual emulated respondent; that is, S220 may function to construct a demographic vector for the current virtual respondent to be emulated. In some embodiments, the current target virtual emulated respondent may be identified based on the input demographic group data (discussed in 2.1 above). In embodiments in which an augmented data generation workflow is configured or initiated, S220 may function to construct a demographic vector based on historical demographic data for a target virtual emulated historical respondent (discussed in 2.1 above).

In one or more embodiments, S220 may function to compute and/or record a number or quantity of virtual respondents previously emulated by the method 200 per each distinct demographic group defined or identified in the input demographic data. In such embodiments, S220 may function to evaluate the number of virtual respondents previously emulated in a demographic group relative to the demographic sample population value associated with the demographic group (as described in 2.1). In some such embodiments, if the number of virtual respondents previously emulated in a particular demographic group has reached (i.e., is equal to or greater than) the demographic sample population value associated with that particular demographic group (i.e., the method 200 has emulated the total number of virtual respondents indicated by the demographic sample population value), S220 may function to identify that particular demographic group as a completed demographic group. In such embodiments, S220 may function to identify another demographic group that is not completed as a new current or target demographic group based on the input demographic data, and S220 may function to construct a demographic vector based on the new current or target demographic group.

As a non-limiting example, the input demographic group data may identify or define one or more distinct demographic groups, each group associated with one or more distinct demographic characteristics. In such an example, S220 may function to construct a first distinct demographic vector based on the distinct demographic characteristics of a first demographic group of the one or more distinct demographic groups. In such an example, S220 may function to identify a current target virtual emulated respondent of the first distinct demographic group based on the first distinct demographic vector. That is, in such an example, the demographic characteristics of the virtual respondent to be emulated may be represented by the first distinct demographic vector.

In a first implementation, S220 may function to construct a distinct demographic vector and may identify the target virtual emulated respondent based on the distinct demographic vector. Alternatively, in a second implementation, one or more target virtual emulated respondents may be identified based on one or more constructed distinct demographic vectors. Additionally, or alternatively, in a third implementation, S220 may function to construct one or more distinct demographic vectors based on the input demographic group data, and S220 may further function to identify the target virtual emulated respondent based on one of the one or more distinct demographic vectors. It shall be noted that any suitable number of distinct demographic vectors may be constructed based on the input demographic group data, and any suitable number of target virtual emulated respondents may be identified based on the distinct demographic vectors and the input demographic group data.

### 2.3 Computing One or More Contextual Question Vectors

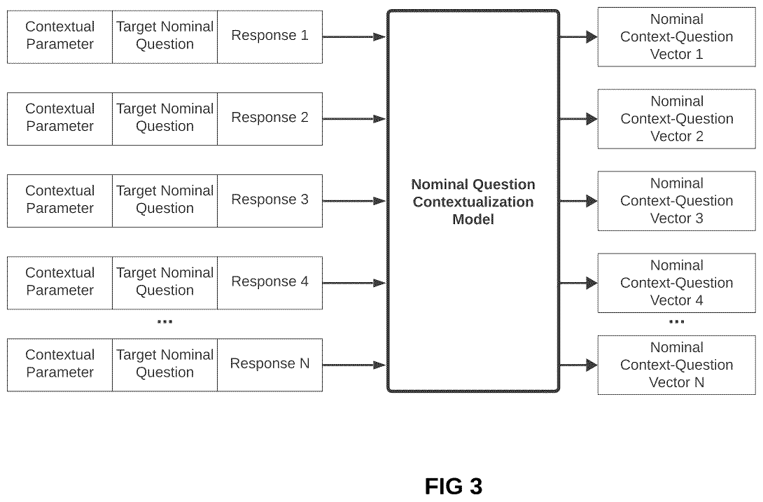

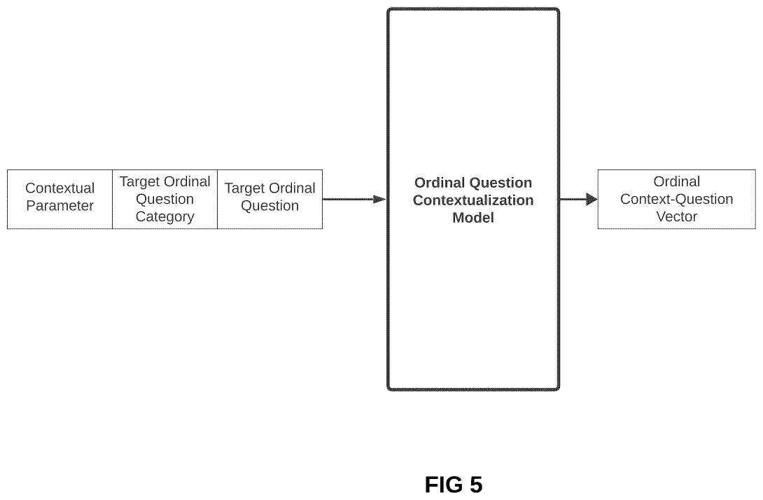

S230, which includes constructing one or more contextual question vectors, may function to construct or compute one or more contextual question vectors based on the user input of survey data (e.g., the reference survey artifact) and any or all previous iterations of the survey simulation for a target virtually emulated respondent. As generally used herein, a contextual question vector (sometimes referred to herein as a “context-question vector”) may refer to a vector representation in n-dimensional space of a distinct question from the reference survey artifact and an iterative contextual parameter (as described below). Preferably, S230 may function to implement a question contextualization machine learning model (e.g., a transformer), or an ensemble of models, that may function to compute or output the one or more contextual question vectors based on inputs that may include the reference survey artifact and an iterative contextual parameter that may be based on previous iterations of the survey simulation for the target virtually emulated respondent, as shown by way of example in FIG. 3 and FIG. 5. Additionally, or alternatively, in some embodiments, S230 may function to compute contextual question vectors for each distinct question in the reference survey artifact with either a nominal response generation model or an ordinal response generation model based on determining whether the corresponding distinct question is a nominal question or an ordinal question. Alternatively, in some embodiments, S230 may function to compute contextual question vectors for any type of question (e.g., nominal, ordinal, and/or any other suitable question) with a multi-task response generation model.

### Iterative Contextual Parameter

In one or more preferred embodiments, S230 may function to include or combine an iterative contextual parameter with other inputs to the question contextualization model. As generally referred to herein, an iterative contextual parameter (sometimes referred to herein as a “contextual parameter” or “evolving contextual parameter”) may relate to a parameter that may be based on one or more previous iterations of the survey simulation for the target virtual emulated respondent. Preferably, the iterative contextual parameter may include data that may relate to, describe, or be based on one or more previous iterations of the virtual respondent emulation or method 200, thus providing context on one or more (or all) previous iterations. In some preferred embodiments, the iterative contextual parameter may include data that may relate to, describe, or be based on one or more (or all) identified or simulated responses and/or the questions associated with the identified responses by the virtual respondent emulation system for the current target virtual emulated respondent. As such, in one or more preferred embodiments, each target virtual emulated respondent may be associated with a distinct iterative contextual parameter that may evolve to include each response of the target virtual emulated respondent as responses are generated by method 200. In some embodiments, the iterative contextual parameter may include data based on previously computed or identified question-response or question-response pairs for the target individual virtually emulated respondent. Additionally, in embodiments in which an augmented data generation workflow has been configured or initiated, the iterative contextual parameter may include the historical question-response pairs for the target virtual emulated historical respondent (described in 2.1 above) as well as any simulated responses or question-response pairs from previous iterations of method 200 for the target virtual emulated historical respondent.

As a non-limiting example, in an instance where the virtual respondent emulation system may emulate a target individual virtual respondent by computing the virtual respondent's answers or responses to a set of questions in a particular reference survey artifact, the method 200 may, for a target virtual emulated respondent, compute a first response “a1” for a first question “q1” and a second response “a2” for a second question “q2”, where “a1”, “a2”, “q1”, and “q2” may relate to specific questions and responses (e.g., text strings containing or related to specific questions and responses from the reference survey artifact). In such a non-limiting example, the method 200 may then function to compute a response by the target virtual emulated respondent to a third question from the reference survey artifact. In such a non-limiting example, the iterative contextual parameter may include data relating to, describing, or based on the computed first and second responses. In some embodiments of such a non-limiting example, the iterative contextual parameter may include data formatted in computed question-response pairs, such that the iterative contextual parameter may include “q1” paired with “a1”, and “q2” paired with “a2”.

It shall be noted that each iteration of S230 and/or method 200 for a target individual may update or evolve the iterative contextual parameter, such that the iterative contextual parameter may include data based on each previous iteration of method 200 for a target individual. For example, the iterative contextual parameter may be updated every iteration based on each computed or simulated response for each virtually emulated respondent. In some preferred embodiments, a first iteration of method 200 for each target virtual emulated respondent may include an empty iterative contextual parameter. Alternatively, in embodiments in which an augmented data generation workflow has been configured or initiated, in a first iteration of method 200 the iterative contextual parameter may include the historical question-response pairs for the target virtual emulated historical respondent (described in 2.1 above).

### Nominal Context-Question Vectors: Question-Response Pairing

In some embodiments, the reference survey artifact may include one or more nominal questions. The term “nominal question,” as generally used herein, may refer to a question or statement that may ask respondents to select a response from a set of response options that may comprise names or labels that may identify different categories that may not be related to one another by rank or order. As a non-limiting example, the reference survey artifact may include the nominal question “What is your primary mode of transportation?” with corresponding response options of “Car,” “Bus,” “Bicycle,” “Walking,” and “Train.” In embodiments in which the reference survey artifact comprises one or more nominal questions, S230 may function to compute one or more nominal context-question vectors for each nominal question.

In some embodiments, S230 may function to construct one or more nominal question-response paired inputs (sometimes referred to herein as “question-response paired inputs”) based on the reference survey artifact. In some preferred embodiments, each iteration of the virtual respondent emulation system and/or method 200 may include identifying a distinct target question or statement from the reference survey artifact. In such embodiments, if S230 identifies the distinct target question as a nominal question, S230 may further function to identify the one or more distinct response or answer options associated with the distinct question in the reference survey artifact. Preferably, each of the one or more nominal question-response paired inputs may be constructed by pairing the distinct question with one of the one or more distinct responses. In one or more embodiments, the distinct question and the one or more distinct responses may be extracted from the reference survey artifact in a text format (e.g., text strings), and in some embodiments the nominal question-response paired inputs may be paired question and response text strings. In some preferred embodiments, the number of nominal question-response paired inputs may be based on or correspond to the number of distinct response options associated with the distinct target question, such that a distinct nominal question-response paired input may be constructed for each distinct response option. As a non-limiting example, a target nominal question in the reference survey artifact may include or be associated with five distinct response options (e.g., answers) to the target question. In such a non-limiting example, S230 may function to construct five distinct nominal question-response paired inputs based on the five distinct responses, such that each of the five distinct question-response paired inputs may include the target question and one of the five distinct responses. It shall be noted that the above example is non-limiting, and the nominal question-response paired inputs may be constructed based on a different quantity and/or configuration of questions and responses from the reference survey artifact as may be suitable for constructing the one or more nominal contextual question vectors. Preferably, a number of responses for a distinct nominal question may be set to a number n, where n is greater than one.

### Constructing One or More Nominal Context-Question Vectors

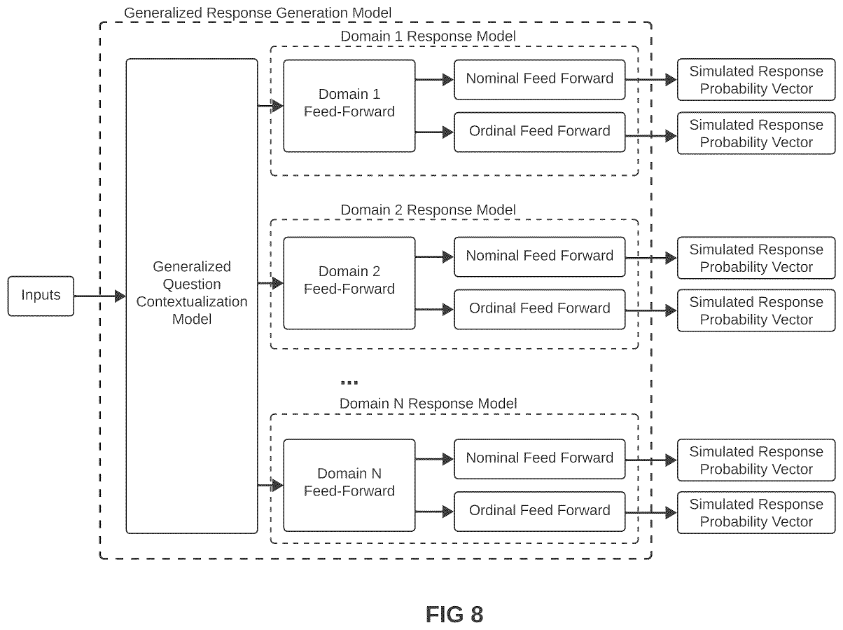

In embodiments in which the reference survey artifact comprises one or more nominal questions, S230 may function to construct or compute one or more nominal contextual question vectors based on the one or more nominal question-response paired inputs and the iterative contextual parameter, as shown by way of example in FIG. 3. As generally used herein, a “nominal context-question vector” may refer to a context-question vector comprising a vector representation of a question-response paired input and the iterative contextual parameter in n-dimensional space. In some embodiments, the one or more nominal contextual question vectors may be computed or constructed by implementing a nominal question contextualization model, which may include a transformer, encoder, large language model, and/or the like. In such embodiments, the one or more question-response paired inputs and the iterative contextual parameter may be provided to the nominal question contextualization model as input. In some embodiments, the iterative contextual parameter may be appended to each question-response paired input before input to the nominal question contextualization model. In turn, the model may process each nominal question-response paired input and the iterative contextual parameter, and the model may compute or output the corresponding one or more nominal context-question vectors. In some preferred embodiments, the number of nominal contextual question vectors output by the model may be equal to or correspond to the number of nominal question-response paired inputs to the model. In some embodiments, the nominal question contextualization model may be a part of the nominal response generation model. Alternatively, in some embodiments, the multi-task response generation model and/or a multi-task question contextualization model, as illustrated in FIG. 8, may function to compute the one or more nominal contextual question vectors.

### Ordinal Context-Question Vectors

In some embodiments, the reference survey artifact may include one or more ordinal questions. The term “ordinal question,” as generally used herein, may refer to a question or statement that may ask respondents to select a response from a set of ordered options, where the ordered options may be ranked from highest to lowest (or vice versa). As a non-limiting example, the reference survey artifact may include the ordinal question “To what extent do you agree with the following statement: ‘I enjoy my job.’” with corresponding response options of “Strongly Agree,” “Agree,” “Neither Agree nor Disagree,” “Disagree,” and “Strongly Disagree.” In such embodiments, S230 may function to construct one or more ordinal contextual question vectors.

In some preferred embodiments, each ordinal question in the reference survey artifact may be associated with a corresponding ordinal question category. As generally used herein, an ordinal question category (sometimes referred to herein as an “ordinal question type”) of an ordinal question may refer to a category or type of a corresponding ordinal question that may inform or define a scale of ordered options according to what type of response the corresponding ordinal question is trying to measure. In some embodiments, an ordinal question category may sometimes be referred to herein as a Likert question category corresponding to a Likert scale. In various embodiments, ordinal question categories may include, but are not limited to, an agreement category or agreement scale, a frequency category or frequency scale, an importance category or importance scale, and/or any other suitable ordinal question category or scale. In some embodiments, all ordinal questions of the same category may be associated with the same ordinal scale, with responses in the same order (e.g., lowest to highest or highest to lowest), to ensure consistency in response generation. In some embodiments, the ordinal scale for each ordinal question category may be a five-point scale, corresponding to five ordered responses to each ordinal question.

As a non-limiting example, the reference survey artifact may include the frequency-category ordinal question, “How often do you use this product?” with corresponding frequency-scale responses of “Never,” “Rarely,” “Sometimes,” “Often,” and “Always.” As another non-limiting example, the reference survey artifact may include the importance-category ordinal question, “How important is this feature to you?” with corresponding importance-scale responses of “Very unimportant,” “Slightly important,” “Important,” “Fairly important,” and “Very important. It shall be noted that the above examples are non-limiting, and the reference survey artifact may include a variety of different categories of ordinal questions.

In one or more embodiments, S230 may function to construct or compute an ordinal contextual question vector corresponding to a distinct ordinal question from the reference survey artifact based on the distinct ordinal question, the category of the distinct ordinal question, and the iterative contextual parameter. As generally referred to herein, an ordinal contextual question vector (sometimes referred to herein as an ordinal context-question vector) may relate to a contextual question vector comprising a vector representation of an ordinal question, its corresponding ordinal question category, and the iterative contextual parameter in n-dimensional space.

In some preferred embodiments, the ordinal context-question vector may be computed or constructed by implementing an ordinal question contextualization model, as shown by way of example in FIG. 5. In some embodiments, the ordinal question contextualization model may include a transformer, encoder, large language model, and/or the like. In some embodiments, S230 may function to append the corresponding ordinal question category to the distinct ordinal question as an ordinal question-category pair, which may be in the form of text (e.g., a text string). In some embodiments, S230 may function to add a category delineating token to the ordinal question-category pair that marks the beginning of the category text of the ordinal question-category pair (e.g., the term “Category:”). Additionally, or alternatively, S230 may function to add a question delineating token to the ordinal question-category pair that marks the beginning of the question text of the question-category pair (e.g., the text “Question:”). As a non-limiting example, a distinct ordinal question may include the question text: “Rate your agreement of the following statement: ‘I like dogs!’” with a corresponding ordinal question category text of: “Agreement.” In such an example, the ordinal question-category pair may comprise the combined text: “Category: Agreement, Question: Rate your agreement of the following statement: ‘I like dogs!’”

In one or more embodiments, for a distinct ordinal question in the reference survey artifact, S230 may function to provide the ordinal question-category pair and the iterative contextual parameter as input to the ordinal question contextualization model. In some embodiments, the iterative contextual parameter may be appended to the ordinal question-category pair such that the ordinal question contextualization model may receive one combined input of the ordinal question-category pair and the iterative contextual parameter. In turn, the ordinal question contextualization model may compute or output an ordinal context-question vector corresponding to the distinct ordinal question. In some embodiments, S230 may function to compute an ordinal context-question vector for each ordinal question in the reference survey artifact. In one or more embodiments, the ordinal question contextualization model may be part of the ordinal question contextualization model. Alternatively, in some embodiments, the multi-task response generation model and/or a multi-task question contextualization model, as illustrated in FIG. 8, may function to compute the one or more ordinal context-question vectors.

### Nominal and Ordinal Question Routing

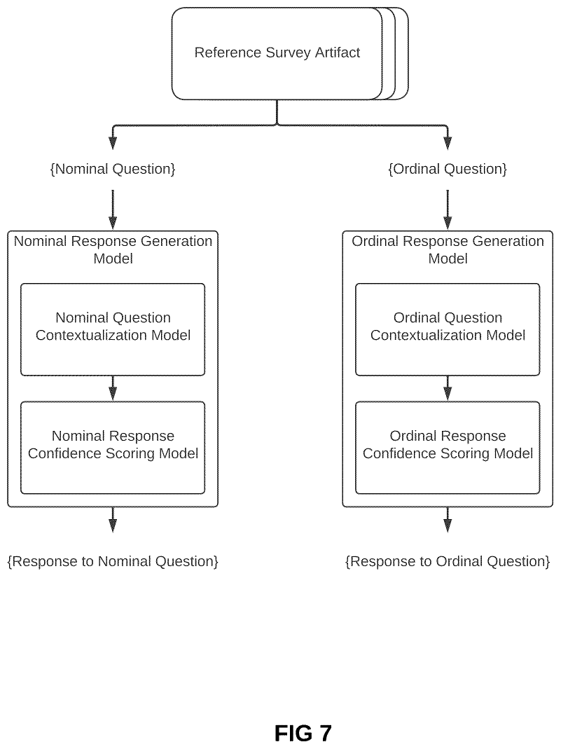

In some embodiments, S230 may function to identify whether the target question of a current iteration of method 200 is a nominal question or an ordinal question. In some such embodiments, as shown by way of example in FIG. 7, if the target question is identified as a nominal question, S230 may in turn route the target question (and/or the reference survey artifact), the response options associated with the target question, and the iterative contextual parameter to the nominal question contextualization model (which may be a part of the nominal response generation model), such that S230 and/or method 200 may generate an appropriate response to the target nominal question. Alternatively, as shown by way of example in FIG. 7, if the target question is identified as an ordinal question, S230 may in turn route the target question (and/or the reference survey artifact), the ordinal question category of the target question, and the iterative contextual parameter to the ordinal question contextualization model (which may be a part of the ordinal response generation model), such that S230 and/or method 200 may generate an appropriate response to the target ordinal question. It shall be noted that, in various embodiments, the reference survey artifact may comprise a combination of ordinal and nominal questions. Alternatively, the reference survey artifact may comprise only ordinal or only nominal questions.

### Multi-Task Response Generation Model

In some embodiments, as shown by way of example in FIG. 8, a multi-task response generation model (sometimes referred to herein as a “generalized response generation model) and/or a multi-task question contextualization model (sometimes referred to herein as a “generalized question contextualization model”) may function to compute responses and/or context-question vectors for both ordinal and nominal questions. In such embodiments, a multi-task question contextualization model may function to compute context-question vectors for each question based on inputs corresponding to the question type. For example, to generate a response and/or a context-question vector for a distinct ordinal question, the input to the multi-task question contextualization model may include the distinct ordinal question, the category of the distinct ordinal question, and the iterative contextual parameter. Additionally, to generate a response and/or a context-question vector for a distinct nominal question, the input to the multi-task question contextualization model may include the corresponding one or more nominal question-response paired inputs and the iterative contextual parameter. In various embodiments, the multi-task question contextualization model may include a transformer, encoder, large language model, and/or the like. In such embodiments, parameters in the multi-task question contextualization model (e.g., parameters in the transformer layer of the multi-task question contextualization model) may be shared for nominal and ordinal question types, which may enable greater learning as nominal and ordinal question types may share highly similar features. Additionally, in such embodiments, the multi-task question contextualization model and/or the multi-task response generation model may reduce or eliminate the need to implement specific models for each question type.

### 2.4 Computing a Simulated Response Probability Vector Based on the One or More Contextual Question Vectors

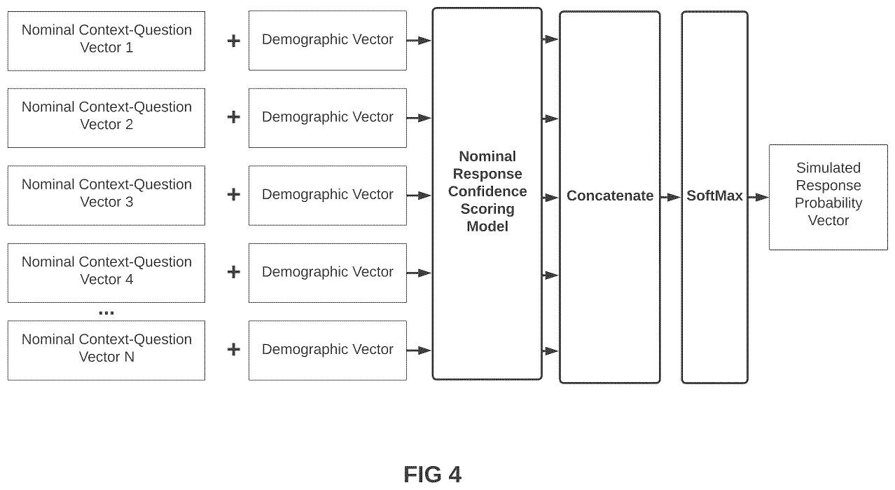

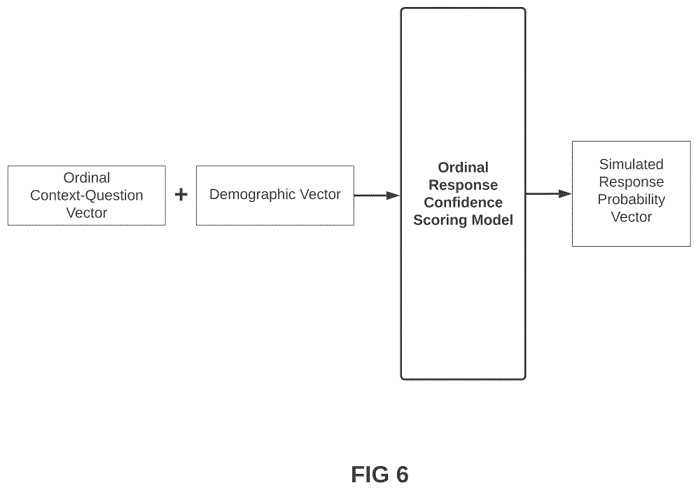

S240, which includes computing a simulated response probability vector based on the one or more contextual question (context-question) vectors, may function to compute a simulated response probability vector for the target virtual emulated respondent to a distinct survey question based on the one or more contextual question vectors and the constructed demographic vector for the target virtual emulated respondent, as shown by way of example in FIGS. 4 and 6. The term “simulated response probability vector” (sometimes referred to herein as the “response probability vector”), as generally used herein, may refer to a vector of one or more probability values that may correspond to a computed probability that the target virtual emulated respondent may select or choose a distinct response or answer from the set of one or more responses or answers associated with the current target question or statement. In some preferred embodiments, S240 may function to implement one or more machine learning models that may compute one or more components of the simulated response probability vector.

### Computing Response Confidence Scores

In some preferred embodiments, S240 may function to generate or compute one or more response confidence scores corresponding to the responses or answers associated with the target question or statement. As generally used herein, a response confidence score (sometimes referred to herein as a “response confidence value” or “response probability score”) may relate to a predicted confidence or probability value that a corresponding response or answer may be selected by the target virtual emulated respondent. That is, a response confidence score for a corresponding response may represent a likelihood that the target virtual emulated respondent would select that corresponding response as an answer to the current question.

In some preferred embodiments, S240 may function to implement a response confidence scoring machine learning model that may output, compute, or predict the one or more response confidence scores. In such preferred embodiments, S240 may function to provide the one or more contextual question vectors as input to the response confidence scoring model. Additionally, in some such preferred embodiments, S240 may function to provide the constructed demographic vector associated with the target virtual emulated respondent as input to the response confidence scoring model with each input contextual question vector. Accordingly, in such embodiments, the response confidence scoring model may output a distinct response confidence score for each input contextual question vector and the constructed demographic vector, whereby the distinct response confidence score may represent a confidence value for the answer or response associated with the corresponding input contextual question vector.

In one or more embodiments, the response confidence scoring model may be a model trained to output the one or more response confidence scores based on inputs of one or more contextual question vectors and a demographic vector. In various embodiments, the response confidence scoring model may be an artificial neural network model (e.g., a feed-forward neural network or the like). Alternatively, in some embodiments, the response confidence scoring model may be any suitable machine learning model or the like for computing one or more response confidence scores.

### Nominal Response Confidence Scoring Model

As shown by way of example in FIGS. 4 and 7, S240 may implement a nominal response confidence scoring model for nominal questions. In embodiments comprising a nominal response generation model, the response confidence scoring model may comprise a nominal response confidence scoring model that may be part of the nominal response generation model. Alternatively, in some embodiments, the nominal response confidence scoring model may be a standalone model. In one or more embodiments, the nominal response confidence scoring model may be trained using nominal question and response datasets and/or a nominal question and response data corpus comprising nominal questions and responses. In various embodiments, for each nominal question, the nominal response confidence scoring model may receive, as input, each of the one or more nominal contextual question vectors and the demographic vector. In turn, the nominal response confidence scoring model may compute, as output, the one or more response confidence scores (and/or the simulated response probability vector described herein).

### Ordinal Response Confidence Scoring Model

As shown by way of example in FIGS. 6 and 7, S240 may implement an ordinal response confidence scoring model for ordinal questions. In embodiments comprising an ordinal response generation model, the response confidence scoring model may comprise an ordinal response confidence scoring model that may be part of the ordinal response generation model. Alternatively, in some embodiments, the ordinal response confidence scoring model may be a standalone model. In one or more embodiments, the ordinal response confidence scoring model may be trained using ordinal question and response datasets and/or an ordinal question and response data corpus comprising ordinal questions and responses. In various embodiments, for each ordinal question, the ordinal response confidence scoring model may receive, as input, the corresponding ordinal contextual question vector and the demographic vector. In turn, the ordinal response confidence scoring model may compute, as output, the one or more response confidence scores (and/or the simulated response probability vector described herein).

In some embodiments, the ordinal response confidence scoring model may function to ensure that predicted (output) response confidence scores may be rank-consistent across ordered response categories of ordinal question. That is, in some embodiments, the ordinal response confidence scoring model may function to maintain the natural ordering of predicted probabilities of ordinal responses to an ordinal question (e.g., the ordering of strongly disagree to strongly agree for an agreement category ordinal question). In some embodiments, the ordinal response confidence scoring model may function to implement a consistent rank logits (CORAL) loss function designed for ordinal regression predictions. In such embodiments, the ordinal response confidence scoring model may ensure that the output response confidence scores for each ordinal question or ordinal question category are consistent and monotonically decreasing as the ordinal responses move from least to most agreeable. This may result in technical benefits of ensuring logical, smooth transitions between class boundaries defined by the ordinal responses, as well as ensuring that higher ordinal response categories (e.g., ordinal responses) always have a lower or equal probability compared to a directly preceding lower ordinal response category. The term “ordinal response category,” as used herein, may refer to a specific response (e.g., “Strongly Agree” or “Strongly Disagree” for an agreement ordinal category question) from among the ordered set of responses to an ordinal question.

### Multi-Task Response Confidence Scoring Model

As shown by way of example in FIG. 8, in some embodiments S240 may implement a multi-task response confidence scoring model to compute response confidence scores and/or to compute the simulated response probability vector. The multi-task response confidence scoring model, as referred to herein, may relate to a model, or an ensemble of models, that may function to generate response confidence scores and/or to compute simulated response probability vectors for both nominal and ordinal questions (and/or any other suitable question type). In some embodiments, the multi-task response confidence scoring model may comprise one or more feed-forward neural networks and/or any other suitable type of model or algorithm. In one or more embodiments, the multi-task response confidence scoring model may be trained using both nominal and ordinal question and response datasets and/or a nominal and ordinal question and response data corpus comprising nominal and ordinal questions and responses. In various embodiments, for each nominal or ordinal question, the multi-task response confidence scoring model may receive, as input, each of the one or more nominal contextual question vectors and the demographic vector (e.g., for a nominal question), or the corresponding ordinal contextual question vector and the demographic vector (e.g., for an ordinal question). In turn, the multi-task response confidence scoring model may compute, as output, the one or more response confidence scores (and/or the simulated response probability vector described herein).

In some embodiments, as shown in FIG. 8, the multi-task response confidence scoring model may include one or more domain-specific response models that may each function to generate response confidence scores, and/or the simulated response probability vector, based on the domain of the current question. The term “domain,” as used herein, may refer to the topic or field of interest that a question in the reference survey artifact may pertain to. In various embodiments, question domains may include, but are not limited to, business-to-business (B2B), business-to-consumer (B2C), social, political polling, healthcare, and/or any other suitable topic or field of interest for a question in a reference survey artifact. In one or more embodiments, each domain-specific model may include a domain-specific feed-forward model or feed-forward layer that may be trained based on a domain-specific question and response data corpus. It shall be noted that the multi-task response confidence scoring model may include any number of domain-specific response confidence scoring models.

### Computing the Simulated Response Probability Vector

Preferably, S240 may function to generate or compute the simulated response probability vector based on the one or more response confidence scores. In some embodiments, S240 may function to implement a concatenate layer and/or a concatenate function (and/or the like) that may in turn function to output a response confidence vector based on inputs of the one or more response confidence scores. In such embodiments, the response confidence vector may include one or more distinct indices or components, whereby each distinct index or component may correspond to a distinct one of the one or more response confidence scores. That is, in some such embodiments, the response confidence vector may relate to a concatenation or joining of the one or more response confidence scores into a single vector.

Additionally, in some preferred embodiments, S240 may function to implement a softmax layer and/or a softmax function (and/or the like) that may in turn function to output the simulated response probability vector based on an input of the response confidence vector. In such embodiments, the softmax layer or softmax function may assign or compute probabilities based on the response confidence vector components. In some preferred embodiments, the computed simulated response probability vector may include one or more indices that may correspond to the one or more indices of the response confidence vector, which may in turn correspond to the one or more responses or answers to the target question. Accordingly, in some preferred embodiments, each index of the computed simulated response probability vector may store a simulated response probability value, each of which may represent a probability that the target virtual emulated respondent may select the answer or response corresponding with the index of the simulated response probability value. Preferably, a sum of all the simulated response probability values stored in the simulated response probability vector may be equal to one, such that each simulated response probability value may represent a fractional probability that the target virtual emulated respondent may select or the corresponding response or answer. Alternatively, in some embodiments, a sum of all the simulated response probability values stored in the simulated response probability vector may not be equal to one.

### 2.5 Identifying a Simulated Response Based on the Simulated Response Probability Vector

S250, which includes identifying a simulated response based on the simulated response probability vector, may function to identify an answer or response of the target virtual emulated respondent to the target question or statement. Preferably, S250 may function to identify the simulated response based on the simulated response probability values stored in the simulated response probability vector. In some embodiments, S250 may function to append the identified simulated response to a simulated response dataset. Additionally, in some preferred embodiments, S250 may function to update the iterative contextual parameter based on the identified simulated response and/or initiate a subsequent iteration of one or more steps of method 200.

### Identifying the Simulated Response

Preferably, S250 may function to identify the simulated response based on the one or more simulated response probability values of the simulated response probability vector. In some embodiments, S250 may function to identify the simulated response by selecting or identifying a target response or answer of the one or more of the responses or answers to the target question based on the simulated response probability value associated with the target response or answer. Accordingly, in some such embodiments, the simulated response probability vector may relate to a probability distribution for identifying the simulated response. In some embodiments, S250 may function to implement a classifier to identify the simulated response based on the simulated response probability vector.

As a non-limiting example, the simulated response probability vector may include a first simulated response probability value of 0.3 that may be associated with a first response to the target question, a second simulated response probability value of 0.4 that may be associated with a second response to the target question, a third simulated response probability value of 0.2 that may be associated with a third response to the target question, and a fourth simulated response probability value of 0.1 that may be associated with a fourth response to the target question. In such an example, each of the simulated response probability values may indicate a probability that S250 may function to identify the associated response as the identified simulated response. It shall be noted that the simulated response probability vector and the simulated response probability values may not be restricted to the sizes, quantities, and/or values described in the above non-limiting example.

In some embodiments, the ordinal response generation model may output a response probability vector and/or a set of response confidence scores that may be associated with the ordinal question category of a target (current) ordinal question. In such embodiments, each of the response confidence scores may be associated with a specific standardized ordinal response based on the ordinal question category ordinal response scale. In some preferred embodiments, the ordinal response scale may be a five-point scale, such that each ordinal question may be standardized to a five-point ordinal response scale (e.g., a five ordinal response scale for agreement-category ordinal questions including the five responses of “Strongly Agree,” “Agree,” “Neither Agree nor Disagree,” “Disagree,” and “Strongly Disagree.”). Alternatively, in some embodiments, each ordinal question may be standardized to a three-point ordinal response scale, and/or any other suitable number for an ordinal response scale.

As a non-limiting example, the ordinal response generation model may compute a response probability vector comprising the five response probability scores of 0.45, 0.3, 0.15, 0.07, and 0.03 for a particular agreement-category ordinal question. In such an example, each response probability score may correspond to one of the five standardized ordinal responses to an agreement-category ordinal question (e.g., “Strongly Agree,” “Agree,” “Neither Agree nor Disagree,” “Disagree,” and “Strongly Disagree.”). In such an example, the probability score of 0.45 may indicate a 45% probability or chance that the current virtual emulated respondent may select “Strongly Agree” as an answer to the current agreement-category ordinal question. Accordingly, S250 may have a 45% chance to select “Strongly Agree” as the identified response to the current ordinal question. It shall be noted that the above example is non-limiting, and the ordinal response generation model may compute different probability scores and/or distributions corresponding to different standardized ordinal response scales and different ordinal question categories.

### Simulated Response Dataset

In some embodiments, S250 may function to append the identified simulated response to a simulated response dataset. The simulated response dataset, as generally referred to herein, may relate to a dataset that may include or store one or more (or all) simulated responses of one or more virtual emulated respondents. Accordingly, in various embodiments, S250 may function to update the simulated response dataset based on identifying the simulated response.

In some embodiments, the simulated response dataset may include one or more distinct emulated respondent data records. As referred to herein, an emulated respondent data record may relate to a data record that may include each simulated response for a distinct or target virtual emulated respondent. In such embodiments, S250 may function to append the simulated response to the distinct emulated respondent data record corresponding to the target virtual emulated respondent.

In embodiments in which an augmented data generation workflow is configured or initiated (described in 2.1 above), S250 may function to augment the reference survey artifact by appending the identified simulated response and/or the simulated response dataset to the reference survey artifact. Additionally, or alternatively, S250 may function to append the historical question-response pairs (described in 2.1) to the simulated response dataset, such that the simulated response dataset augments the historical question-response pairs.

### Updating the Iterative Contextual Parameter

In one or more preferred embodiments, S250 may function to update the iterative contextual parameter based on the identified simulated response. In some embodiments, the iterative contextual parameter may include data that may relate to, describe, or be based on one or more (or all) identified or simulated responses and/or the questions associated with the identified responses by the virtual respondent emulation system for the current target virtual emulated respondent (as described in 2.3). Preferably, upon identifying a simulated response, S250 may function to update the iterative contextual parameter based on the identified simulated response. In a preferred embodiment, S250 may function to modify or update the iterative contextual parameter by adding or appending the identified simulated response and/or the target question to the iterative contextual parameter.

In some embodiments, S250 may additionally or alternatively function to initiate a subsequent iteration of one or more steps of method 200. In such embodiments, S250 may function to initiate the subsequent iteration based on a completion status of the reference survey artifact for the current target virtual emulated respondent. In some embodiments, the completion status of the reference survey artifact may be based on identifying a simulated response for each question or statement in the reference survey artifact for the current target virtual emulated respondent.

As a non-limiting example, S250 may function to identify or evaluate if a simulated response to each question of the reference survey artifact has been identified for the target virtual emulated respondent. In such an example, if a simulated response has not been identified for each question, S250 may function to initiate a subsequent iteration of S230, S240, and/or S250 to identify a simulated response of the current target virtual emulated respondent to a subsequent target question of the reference survey artifact. Alternatively, in such an example, if a simulated response has been identified for each question, S250 may function to initiate a subsequent iteration of S220, S230, S240, and/or S250 to identify one or more simulated responses of a subsequent target virtual emulated respondent (for example, a subsequent target virtual emulated respondent based on a subsequent constructed demographic vector). It shall be noted that the above example may be non-limiting, and a subsequent iteration of any number or sequence of steps of method 200 may be initiated based on any suitable condition for initiating a subsequent iteration.

### 2.55 Storing a Simulated Response Dataset in a Queryable Computer Database

In some embodiments, method 200 may include S255, which may include storing the simulated response dataset in a queryable computer database. In such embodiments, S255 may function to store the simulated response dataset (described in 2.5) in a computer database that may be queried or accessed (e.g., via a user interface) to augment or complete a target reference survey artifact with one or more simulated responses of the simulated response dataset. In some such embodiments, the queryable computer database may be

As generally used herein, the term “queryable computer database” may refer to a structured or unstructured collection of data and/or datasets that may be accessed and manipulated to enable retrieving, updating, deleting, and/or managing of simulated response datasets. In various embodiments, the queryable computer database may comprise one or more local or remote data storage devices including, but not limited to, one or more local and/or remote servers, one or more hard drives, one or more solid state drives, network storage, one or more cloud servers and/or cloud data storage devices, and/or any other suitable data storage devices or combinations thereof.

In some embodiments, S255 may function to implement a user interface (e.g., a graphical user interface) that may enable one or more users to access one or more simulated response datasets in the queryable computer database. In such embodiments, the user interface may enable the one or more users to construct and execute queries for simulated response datasets and/or for simulated responses from a distinct simulated response dataset. The user interface may function to surface simulated responses to the one or more users (e.g., via a text view or text area component of the user interface).

In some embodiments, the user interface may enable the one or more users to upload a target reference survey artifact to the queryable computer database. In some embodiments, S255 may function to augment or complete the target reference survey artifact with one or more simulated responses of a corresponding simulated response dataset in the queryable computer database. As a non-limiting example, method 200 may generate a simulated response dataset based on a target reference survey artifact comprising one or more unanswered questions. In such an example, S255 may function to enable one or more users to augment or complete the target reference survey artifact with the simulated responses of the generated simulated response dataset.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

What is claimed:

1. A computer-implemented method for an automated generation of simulated responses from a virtual emulated respondent, the method comprising:
collecting a reference survey artifact comprising one or more unanswered questions;
obtaining demographic data comprising one or more demographic features;
constructing, via one or more computers, a demographic vector based on the demographic data, wherein the demographic vector represents one or more demographic characteristics of a target virtual emulated respondent;
generating, via the one or more computers, a response to each distinct unanswered question for the target virtual emulated respondent, wherein generating the response to each distinct unanswered question comprises:
routing a set of inputs to one of a nominal response generation model or an ordinal response generation model, wherein the set of inputs includes the demographic vector, the distinct unanswered question, and an iterative contextual parameter, and
generating, via the nominal response generation model or the ordinal response generation model, a simulated response to the distinct unanswered question;
updating, via the one or more computers, a simulated response dataset to include each generated response of the target virtual emulated respondent; and
storing the simulated response dataset in a queryable computer database accessible, via a user interface, for augmenting or completing a target reference survey artifact with one or more simulated responses of the simulated response dataset.

2. The computer-implemented method according to claim 1, wherein generating the response to each distinct unanswered question further comprises determining whether the distinct unanswered question is a nominal question or an ordinal question, and routing the set of inputs to one of the nominal response generation model or the ordinal response generation model further comprises:
routing the set of inputs to the nominal response generation model if the distinct unanswered question is a nominal question, or
routing the set of inputs to the ordinal response generation model if the distinct unanswered question is an ordinal question.

3. The computer-implemented method according to claim 1, wherein computing the response to the distinct unanswered question further comprises computing, via the nominal response generation model or the ordinal response generation model, one or more context-question vectors comprising an n-dimensional vector representation of the distinct unanswered question and the iterative contextual parameter.

4. The computer-implemented method according to claim 3, wherein computing the one or more context-question vectors comprises computing, via the nominal response generation model, a context-question vector of the one or more context-question vectors for each possible response to the distinct unanswered question, wherein each context-question vector comprises an n-dimensional vector representation of the distinct unanswered question, the corresponding possible response, and the iterative contextual parameter.

5. The computer-implemented method according to claim 1, wherein computing the response to the distinct unanswered question further comprises computing, via the ordinal response generation model, an ordinal context-question vector comprising an n-dimensional vector representation of the distinct unanswered question, an ordinal question category of the distinct unanswered question, and the iterative contextual parameter.

6. The computer-implemented method according to claim 1, wherein the iterative contextual parameter comprises one or more previously generated responses of the target virtual emulated respondent.

7. The computer-implemented method according to claim 1, wherein computing the response to the distinct unanswered question further comprises:
computing, via the nominal response generation model or the ordinal response generation model, a response probability score for each possible response to the distinct unanswered question, and
selecting, via the nominal response generation model or the ordinal response generation model, the generated response from among the possible responses based on the computed response probability scores.

8. The computer-implemented method according to claim 1, wherein the reference survey artifact comprises one or more previously answered questions by at least one historical respondent, and the one or more unanswered questions include one or more questions that the at least one historical respondent did not previously answer, wherein the target virtual emulated respondent represents a virtual emulation of the at least one historical respondent.

9. The computer-implemented method according to claim 1, wherein constructing the demographic vector further comprises automatically selecting values for one or more characteristic indices of the demographic vector, wherein each characteristic index is associated with a distinct demographic characteristic.

10. The computer-implemented method according to claim 1, wherein generating the response to each distinct unanswered question further comprises updating the iterative contextual parameter to include the generated response and the distinct unanswered question.

11. A method for an automated generation of simulated responses from one or more virtual emulated respondents, the method comprising:
collecting, via one or more computers, a reference survey artifact comprising one or more unanswered questions;
obtaining, via the one or more computers, demographic group data comprising one or more demographic features of one or more demographic groups of one or more virtual emulated respondents;
constructing one or more demographic vectors based on the demographic group data, wherein each demographic vector represents one or more demographic characteristics of a distinct demographic group of the one or more demographic groups;
iteratively generating, for each distinct virtual emulated respondent in each demographic group, a simulated response to each distinct unanswered question, wherein iteratively generating a simulated response includes:
(i) routing a set of inputs to one of a nominal response generation model or an ordinal response generation model based on a question type of the distinct unanswered question, wherein the set of inputs comprises the distinct unanswered question and the demographic vector corresponding to the demographic group of the distinct virtual emulated respondent,
(ii) computing, via the nominal response generation model or the ordinal response generation model, a response probability vector comprising one or more probability values corresponding to one or more possible responses of the distinct virtual emulated respondent to the distinct unanswered question,
(iii) automatically selecting the simulated response from the one or more possible responses based on the response probability vector, and
(iv) updating a simulated response dataset to include the selected simulated response.

12. The method according to claim 11, wherein iteratively generating the simulated response further comprises determining whether the distinct unanswered question is a nominal question or an ordinal question, and routing the set of inputs to one of the nominal response generation model or the ordinal response generation model further comprises:
routing the set of inputs to the nominal response generation model if the distinct unanswered question is a nominal question, or
routing the set of inputs to the ordinal response generation model if the distinct unanswered question is an ordinal question.

13. The method according to claim 11, wherein computing the response probability vector further comprises computing, via the nominal response generation model or the ordinal response generation model, one or more context-question vectors comprising an n-dimensional vector representation of the distinct unanswered question and an iterative contextual parameter comprising one or more previously generated simulated responses of the distinct virtual emulated respondent.

14. The method according to claim 13, wherein computing the one or more context-question vectors comprises computing, via the nominal response generation model, a context-question vector of the one or more context-question vectors for each possible response to the distinct unanswered question, wherein each context-question vector comprises an n-dimensional vector representation of the distinct unanswered question, the corresponding possible response, and the iterative contextual parameter.

15. The method according to claim 11, wherein computing the response probability vector further comprises computing, via the ordinal response generation model, an ordinal context-question vector comprising an n-dimensional vector representation of the distinct unanswered question, an ordinal question category of the distinct unanswered question, and an iterative contextual parameter comprising one or more previously generated simulated responses of the distinct virtual emulated respondent.

16. A computer-implemented method for an automated generation of simulated responses from a virtual emulated respondent, the method comprising:
collecting a reference survey artifact comprising one or more unanswered questions;
obtaining demographic data comprising one or more demographic features;
constructing, via one or more computers, a demographic vector based on the demographic data, wherein the demographic vector represents one or more demographic characteristics of a target virtual emulated respondent;
generating, via the one or more computers, a response to each distinct unanswered question for the target virtual emulated respondent, wherein generating the response to each distinct unanswered question comprises:
transmitting a set of inputs to a multi-task nominal-ordinal response generation model, wherein the set of inputs includes the demographic vector, the distinct unanswered question, and an iterative contextual parameter, and
generating, via the multi-task nominal-ordinal response generation model, a simulated response to the distinct unanswered question;
updating, via the one or more computers, a simulated response dataset to include each generated response of the target virtual emulated respondent; and
storing the simulated response dataset in a queryable computer database accessible, via a user interface, for augmenting or completing a target reference survey artifact with one or more simulated responses of the simulated response dataset.

17. The computer-implemented method according to claim 16, wherein generating the response to each distinct unanswered question further comprises:
computing, via the multi-task nominal-ordinal response generation model, a nominal context-question vector for each possible response to the distinct unanswered question if the distinct unanswered question is a nominal question, wherein each context-question vector comprises an n-dimensional vector representation of the distinct unanswered question, the corresponding possible response, and the iterative contextual parameter, or
computing, via the multi-task nominal-ordinal response generation model, an ordinal context-question vector if the distinct unanswered question is an ordinal question, wherein the ordinal context-question vector comprises an n-dimensional vector representation of the distinct unanswered question, an ordinal question category of the distinct unanswered question, and the iterative contextual parameter.

18. The computer-implemented method according to claim 16, wherein generating the simulated response to the distinct unanswered question further comprises appending the distinct unanswered question and the simulated response to the iterative contextual parameter.

19. The computer-implemented method according to claim 16, wherein the reference survey artifact comprises one or more previously answered questions by at least one historical respondent, and the one or more unanswered questions include one or more questions that the at least one historical respondent did not previously answer, wherein constructing the demographic vector further comprises constructing the demographic vector based on demographic data of the at least one historical respondent.

20. The computer-implemented method according to claim 16, wherein constructing the demographic vector further comprises automatically selecting values for one or more characteristic indices of the demographic vector, wherein each characteristic index is associated with a distinct demographic characteristic of the one or more demographic characteristics.
